(19) United States
(12) Patent Application Publication
(10) Pub. No.: US 2016/0152095 A1
(43) Pub. Date: Jun. 2, 2016

(54) TIRE COMPRISING A HIGH-CONTRAST MARKING

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Eric BERGER, Clermont-ferrand (FR); Benoit GARDARIN, Clermont-ferrand (FR); Bruno GUIMARD, Clermont-ferrand (FR); Olivier MUHLHOFF, Clermont-ferrand (FR); Sylvain PETITJEAN, Clermont-ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 14/898,649

(22) PCT Filed: Jun. 19, 2014
(86) PCT No.: PCT/EP2014/062957

§ 371 Date: Dec. 15, 2015

(30) Foreign Application Priority Data
Jun. 20, 2013 (FR) 1355823

(51) Int. Cl. B60C 13/00; B60C 13/04

(52) U.S. Cl. CPC B60C 13/001; B60C 13/04

(57) ABSTRACT

A tire made of rubber material having a sidewall and a marking. This marking is positioned in a housing recessed into the sidewall. The tire includes a texture having a plurality of strands distributed at a density at least equal to five strands per square millimeter (mm²), each strand having a mean cross section of between 0.0007 mm² and 0.06 mm² and/or the texture having a plurality of substantially mutually parallel lamellae, the spacing of the lamellae being at most equal to 0.5 mm, each lamella having a mean width of between 0.03 mm and 0.3 mm. The texture surrounds all or part of the marking in the housing.

This application is a 371 national phase entry of PCT/EP2014/062957, filed 19 Jun. 2014, which claims benefit of French Patent Application No. 1355823, filed 20 Jun. 2013, the contents of which are incorporated herein by reference for all purposes.

### BACKGROUND

The present disclosure relates to a tire for a motor vehicle comprising a marking and a special texture surrounding this marking.

### DESCRIPTION OF RELATED ART

Tire sidewalls have a great many markings intended to provide technical and legal information or to allow consumers to discern the origin of the product.

Attempts are constantly being made at improving the visibility and legibility of these markings on tire sidewalls.

Document EP2204206 describes a texture present on the external surface of a tire sidewall. This texture comprises a plurality of strands uniformly distributed in this texture.

Document US 2008/0283169 describes a tire made of rubber material comprising a sidewall and a marking formed on this sidewall. The marking is positioned in a housing recessed into the sidewall. This marking protrudes from the bottom of the housing so that it enjoys good visibility on the tire sidewall.

However, during running, large amounts of mud or dust may become lodged in the housing, thereby reducing the contrast between the marking and the bottom of the housing.

There is therefore a need to propose a solution that allows high-contrast marking to be preserved on the sidewall of a tire as this tire runs.

### DEFINITIONS

A “tire” means any type of resilient tire whether or not subjected to an internal pressure.

The “tread” of a tire means a quantity of rubber material delimited by lateral surfaces and by two main surfaces, one of which is intended to come into contact with a roadway when the tire is running.

The “sidewall” of a tire means a lateral surface of the tire positioned between the tire tread and a bead of this tire.

A “marking” on a tire sidewall means indications on this sidewall intended to provide technical and legal information or to allow consumers to discern the origin of the product.

A “texture” means an organized arrangement of a plurality of elements, all or part of the elements of the arrangement being repeats of one single basic element, for example a strand or a lamella.

A “strand” means a filiform element of which the height is at least equal to twice the diameter of a disc having the same surface area as a mean cross section of this strand.

A “mean cross section” of a strand means the mean of the cross sections measured at regular intervals from the base of the strand to the tip of this strand.

A “lamella” means elongate strands that have a length at least equal to twice their height.

The “mean width” of a lamella means the mean of the widths measured at regular intervals from the base of the lamella to the tip of this lamella.

### SUMMARY

The invention, according to an embodiment, relates to a tire made of rubber material comprising a sidewall and a marking. This marking is positioned in a housing recessed into the sidewall. The tire comprises a texture comprising a plurality of strands distributed at a density at least equal to five strands per square millimetre (mm²), each strand having a mean cross section of between 0.0007 mm² and 0.06 mm² and/or the said texture comprising a plurality of substantially mutually parallel lamellae, the spacing of the lamellae being at most equal to 0.5 mm, each lamella having a mean width of between 0.03 mm and 0.3 mm. The texture surrounds all or part of the marking in the housing.

The texture surrounding the marking and formed by strands or lamellae affords numerous advantages. On the one hand, this texture allows all or some of the incident rays of light that encounter the sidewall to become “trapped”. This makes it possible to give the area around the marking a darker appearance thereby improving its contrast and therefore its visibility against the rest of the sidewall. On the other hand, this special texture makes it possible to obtain a pleasant “velour” like feel to the sidewall. Finally, the texture used has hydrophobic properties which means that it is easier for water, dust or mud to drain from the housing in which the marking is present. Thus the visibility of the marking on the tire sidewall over the course of time is preserved.

In one alternative form of embodiment, the strands of the texture or, respectively, the lamellae of the texture, end flush with the sidewall of the tire.

In this way, these strands or, respectively, these lamellae, extend the sidewall of the tire. The overall visual impression of the tire sidewall is thus improved.

In another alternative form of embodiment, the strands of the texture or, respectively, the lamellae of the texture, are set back in the housing.

The housing affords protection to the texture. This then improves the durability of this texture.

In another alternative form of embodiment, the strands of the texture or, respectively, the lamellae of the texture, protrude beyond the sidewall of the tire.

The emerging parts of the strands or, respectively, of the lamellae, of the texture have a certain flexibility because of their slenderness. When the texture experiences rubbing, these strands or, respectively, these lamellae, deform, thereby absorbing some of the force of this rubbing. In this way, the marking is protected against wear and becomes more durable. Furthermore, the fact that the strands or, respectively, the lamellae, of the texture protrude beyond the sidewall of the tire affords an overall improvement to the tactile effect of the texture.

In one preferred embodiment, part of the strands of the texture or, respectively, part of the lamellae of the texture, protrude beyond the sidewall of the tire and another part of these strands or, respectively, of these lamellae, are set back in the housing.

This makes it possible to strike a good balance between protecting the texture and protecting the marking.

### BRIEF DESCRIPTION OF THE DRAWINGS

Further features and advantages of the embodiments of the invention will become apparent from the following description, given by way of non limiting example, with reference to the attached drawings in which:

FIG. 1 is a schematic perspective view of a tire sidewall and of a marking present on this sidewall;

FIG. 2 is a view in section on X-X of FIG. 1, of a texture surrounding the marking present on the sidewall, according to a first embodiment of the invention;

FIG. 3 is a view in section on X-X of FIG. 1, of a texture surrounding the marking present on the sidewall, according to a second embodiment of the invention;

FIG. 4 is a view in section on X-X of FIG. 1, of a texture surrounding the marking present on the sidewall, according to a third embodiment of the invention;

FIG. 5 depicts the condition of the texture of FIG. 4 when the sidewall is rubbed;

FIG. 6 is a view in section on X-X of FIG. 1, of a texture surrounding the marking present on the sidewall according to a fourth embodiment of the invention;

FIG. 7 is a schematic view of a texture surrounding the marking of FIG. 1 and comprising strands;

FIG. 8 is a schematic view of a texture surrounding the marking of FIG. 1 and comprising lamellae.

### DETAILED DESCRIPTION OF SPECIFIC EMBODIMENTS

In the description which will follow, elements that are substantially identical or similar will be denoted by identical references.

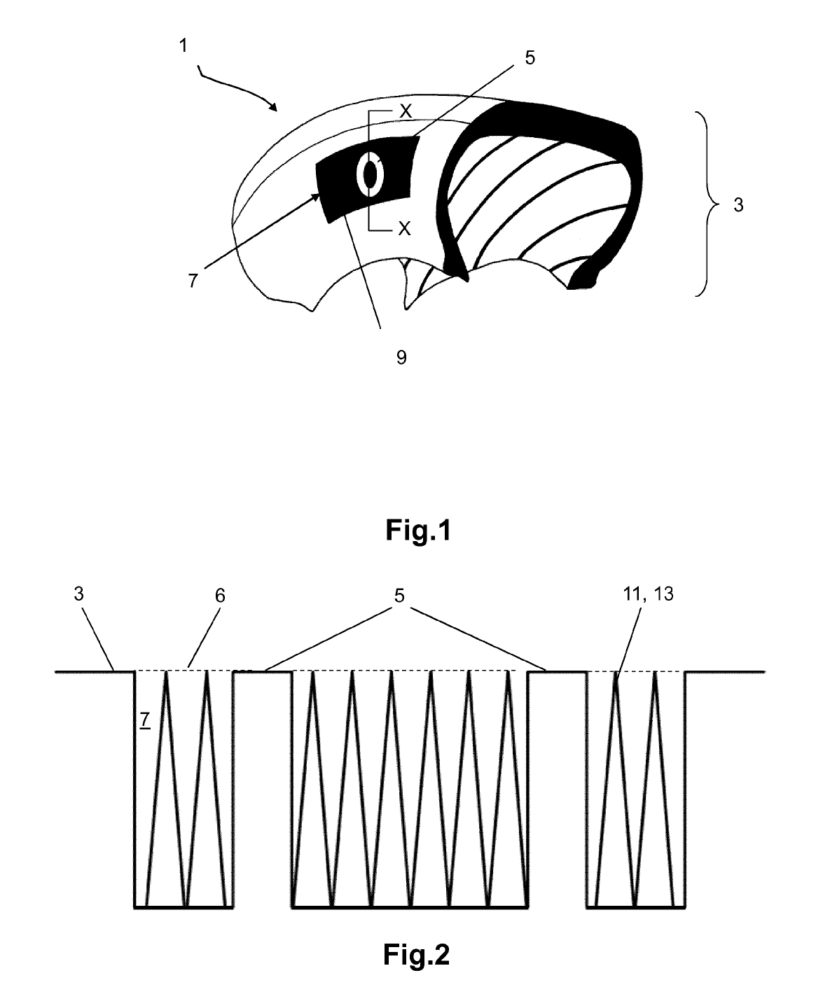

FIG. 1 depicts a sidewall 3 of a tire 1. This tire sidewall comprises a marking 5 positioned in a housing 7. This housing 7 is recessed into the sidewall. The tire further comprises a texture 9 surrounding the marking 5 in the housing. In the example of FIG. 1, the marking is completely surrounded by the texture 9. As an alternative, this marking 5 may be partially surrounded by this texture 9. It will be noted that the texture and the marking are very distinct here. Indeed, the texture does not form the marking but surrounds it to improve the visibility of this marking on the sidewall.

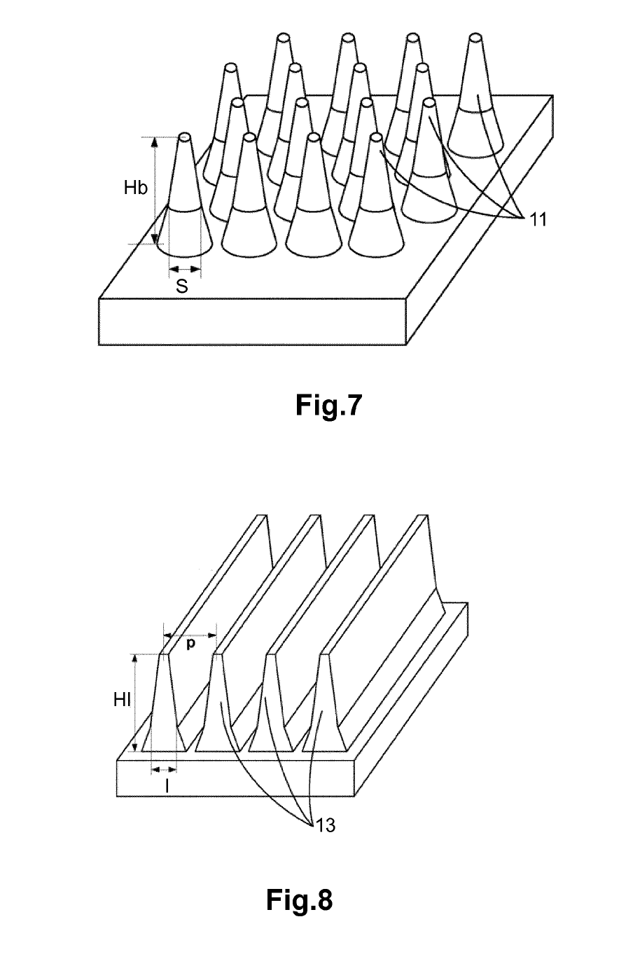

In addition, the texture 9 comprises a plurality of strands 11, as depicted in FIG. 7. In this figure, the strands 11 have a conical overall shape with a cross section that reduces along the height Hb of these strands. More specifically, the mean cross section of each strand, which corresponds to the mean of the cross sections S measured at regular intervals from the base of the strand upwards, is between 0.0007 mm² and 0.06 mm². In the texture 9, the strands are distributed with a density at least equal to five strands per square millimetre.

In an alternative form of embodiment, the texture 9 comprises a plurality of lamellae 13, as depicted in FIG. 8. In this figure, the lamellae 13 have a triangular overall cross section and the mean width of each lamella, corresponding to the mean of the width 1 measured at regular intervals along the height H1 of the lamella, is between 0.03 mm and 0.3 mm. In the texture 9, the lamellae 13 are substantially mutually parallel and the spacing P of the lamellae is at most equal to 0.5 mm.

In another alternative form of embodiment, the texture 9 comprises a combination of strands 11 and of a lamellae 13.

FIG. 2 depicts a view in cross section of the texture surrounding the marking 5 according to a first embodiment of the invention. This texture may comprise strands 11 and/or lamellae 13.

More specifically, the strands 11 of the texture or, respectively, the lamellae 13 of the texture, here end flush with the sidewall 3 of the tire, which means to say that the tips of these strands 11 or, respectively, the tips of these lamellae 13, lie at the same level as the level 6 extending the sidewall 3 above the housing 7.

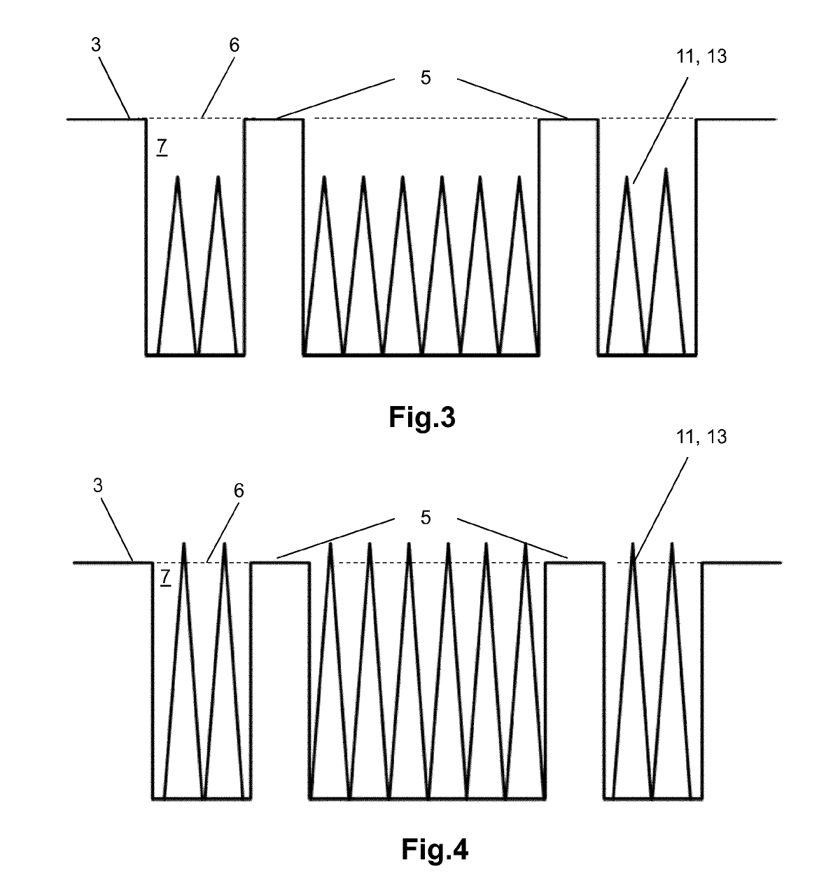

In an alternative form of embodiment visible in FIG. 3, the strands 11 of the texture or, respectively, the lamellae 13 of the texture, are set back in the housing 7 of the sidewall 3, which means to say that the tips of these strands 11 or, respectively, the tips of these lamellae 13, are below the level 6 extending the sidewall.

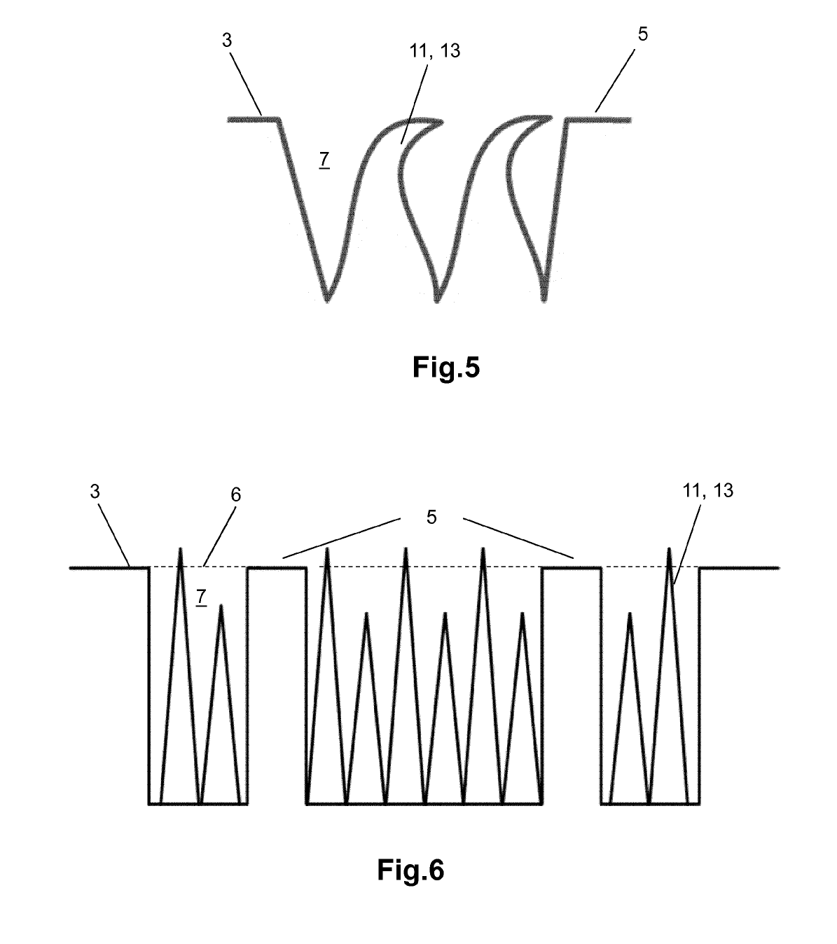

In another alternative form of embodiment visible in FIG. 4, the strands 11 of the texture or, respectively, the lamellae 13 of the texture, protrude beyond the sidewall 13 of the tire, which means to say that the tips of these strands 11 or, respectively, the tips of these lamellae 13, protrude beyond the level 6 extending the sidewall. If the tire sidewall is rubbed in the region of the texture, the strands 11 or, respectively, the lamellae 13, flex, as can be seen in FIG. 5, absorbing all or some of the force of this rubbing.

In another alternative form of embodiment visible in FIG. 6, part of the strands 11 of the texture or, respectively, part of the lamellae 13 of the texture, protrude beyond the sidewall 13 of the tire and another part of these strands 11 or, respectively, of these lamellae 13, are set back in the housing. For preference, at least 50% of the strands 11 or, respectively, of the lamellae 13, protrude beyond the sidewall 13.

The embodiments of the invention are not restricted to the examples described and depicted and various modifications can be made thereto without departing from its scope.

In FIGS. 2 to 4 and in FIG. 8, the marking 5 is represented as protruding from the bottom of the housing 7 and ending flush with the sidewall 3. As an alternative, the height of the marking 5 may be less than the depth of the housing 7 so that the marking is set back in the housing 7.

Furthermore, the tire sidewall may comprise other markings which do not have around them a texture as described in the embodiments of the invention.

In addition, in FIG. 1 the texture 9 is depicted as completely filling the housing 7. As an alternative, this texture 9 is present in just part of the housing 7, around the marking 5.

Finally, the lamellae 13 of FIG. 8 may be discontinuous. They may further have differences in cross section from one another.

1. A tire made of rubber material comprising
a sidewall and
a marking, this marking being positioned in a housing recessed into the sidewall, the tire comprising
a texture comprising a plurality of strands distributed at a density at least equal to five strands per square millimeter (mm²), each strand having a mean cross section of between 0.0007 mm² and 0.06 mm² and/or
the texture comprising a plurality of substantially mutually parallel lamellae, a spacing of the lamellae being at most equal to 0.5 mm, each lamella having a mean width of between 0.03 mm and 0.3 mm,
wherein the texture surrounds all or part of the marking in the housing.

2. The tire according to claim 1, wherein the strands of the texture or, respectively, the lamellae of the texture, end flush with the sidewall of the tire.

3. The tire according to claim 1, wherein the strands of the texture or, respectively, the lamellae of the texture, are set back in the housing.

4. The tire according to claim 1, wherein the strands of the texture or, respectively, the lamellae of the texture, protrude beyond the sidewall of the tire.

5. The tire according to claim 1, wherein
part of the strands of the texture or, respectively, part of the lamellae of the texture, protrude beyond the sidewall of the tire and
another part of these strands or, respectively, of these lamellae, are set back in the housing.
